(19) United States
(12) Patent Application Publication
(10) Pub. No.: US 2008/0145681 A1
(43) Pub. Date: Jun. 19, 2008

(54) Reinforced Humidity Adaptive Vapor Retarding Film and Method of Manufacture

(76) Inventors: Murray S. Toas, Norristown, PA (US); Michael J. Lembo, Souderton, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/955,909

(22) Filed: Dec. 13, 2007

Related U.S. Application Data
(63) Continuation-in-part of application No. 10/704,317, filed on Nov. 6, 2003, now abandoned.
Application No. 10/704,317 is a continuation-in-part of application No. 10/947,186, filed on Sep. 23, 2004.
Application No. 10/947,186 is a continuation-in-part of application No. 11/182,383, filed on Jul. 15, 2005.
Application No. 11/182,383 is a continuation-in-part of application No. 11/675,129, filed on Feb. 15, 2007.

(51) Int. Cl. B32B 27/32; B05B 7/16

(52) U.S. Cl. 428/500; 428/411.1; 264/112; 118/302

(57) ABSTRACT

A reinforced humidity adaptive, vapor retarding film and a method of manufacture thereof includes, a combination of a thin film and melt bonded thermoplastic fibers, the combination having a tear strength greater than that of the thin film alone and at least the same as a minimum tear strength required to withstand shipping, handling and installation of an unreinforced thicker film of the same material as the thin film.

This application is a continuation-in-part of each of the following U.S. patent applications, the entirety thereof being hereby incorporated by reference herein;

U.S. patent application Ser. No. 10/704,317, filed Nov. 6, 2003 (D0932-00399);

U.S. patent application Ser. No. 10/947,186, filed Sep. 23, 2004 (U.S. 2006/0059852 A1);

U.S. patent application Ser. No. 11/182,383 filed Jul. 15, 2005 (D0932-00539) and

U.S. patent application Ser. No. 11/675,129 filed Feb. 15, 2007 (D0932-00772).

### BACKGROUND OF THE INVENTION

1. Field of the Invention

The present invention relates to a water vapor retarder having a water vapor permeability dependent on ambient humidity and a method of manufacturing the same.

2. Background of the Invention

Building materials, such as fiber insulation batts and fiber insulation slabs attached to a facing material are known. For example, U.S. Pat. No. 5,848,509 describes an encapsulated insulation assembly in which a fiber insulation batt and a polymer film are moved along a longitudinal path and adhered to each other. Other patent publications of interest include U.S. Pat. No. 5,501,872 to Allen et al.; U.S. Pat. No. 6,905,563 to Dong; U.S. Pat. No. 6,808,772 to Kunzel et al.; U.S. Published Application No. 2007/0026185 A1; U.S. Published Application No. 2007/0015424 A1 (D0932-00539); and U.S. application Ser. No. 11/675,129, filed 15 Feb. 2007 (D0932-00734); which are hereby incorporated by reference.

In many instances of manufacture, the facing materials used are kraft paper with an asphalt or bituminous coating and other polymeric materials to provide both support for the underlying fibers and to provide a liquid water and/or water vapor retarder. A smart vapor retarder is used as sheeting for covering insulation materials installed in wall and ceiling cavities. A build-up of excess moisture in the insulation is avoided by allowing the excess moisture to escape by vapor diffusion through the film thickness of the vapor retarder.

A smart vapor retarder is a coating or film formed by a material, a polyamide, for example, that changes its water moisture vapor permeability in direct relationship with increases and/or decreases of the ambient humidity conditions. This transformation allows drying to occur through the process of vapor diffusion, thereby improving the speed of drying of the insulation and building materials. The film allows trapped moisture to escape, thereby alleviating a consequent formation of mold and water damage typically resulting from excess trapped moisture.

For example, U.S. Patent Application Publication No. 2004/0103603, which is incorporated by reference herein, describes the attachment of a vapor retarder, such as polyamide films, to insulation or other building materials such as gypsum board, particle board, etc. This vapor retarder imparts a water vapor diffusion resistance, permeability and/or transmission which depend on the ambient humidity.

One disadvantage of a smart vapor retarder is that the material cost may be higher than a conventional vapor retarder. For example, a polyamide material cost may be approximately three times the material cost of an inexpensive water vapor retarder material, such as, polyethylene. The higher material cost is a disincentive for the construction industry to use a smart vapor retarder, instead of using a less costly, vapor retarder film of polyethylene having little water vapor diffusion properties. Accordingly, it would be advantageous for a smart vapor retarder to have a reduced material content, which would reduce the material cost, and serve as an incentive for the construction industry to use a smart vapor retarder.

One proposed technique for reducing the material cost of a smart vapor retarder is to reduce its film thickness. However, reducing a film's thickness also reduces its tear resistance and reduces its tensile strength, which reduces its ability to be shipped and handled easily and quickly at a construction site by persons who unfold rolls of film up to twelve feet wide and who use a stapling gun to staple the film to wooden framing members in a building, and who staple the tabs of the film that is laminated to a fibrous thermal insulation batt to wooden framing members. Moreover, a thin film less than 0.001 inches (25 micrometers) thick can be torn by driving a metal staple therethrough. Further, a thin film is unable to support its own weight without tearing, and especially is unable to support the weight of an insulation material laminated to the film when the film and insulation are installed with staples in ceilings or walls. Further, a thin film laminated to mineral fiber insulation is exposed to potential damage and tearing during the compression packaging process in which a stack of film laminated insulation batts is compressed from a height of 10 feet to 8 inches and pushed through a metal snout into a plastic bag. Decreasing a film's thickness also increases its water vapor permeability. There are smart vapor retarder films that can be reduced in thickness to less than a range of about 25 microns and to less than about 10 microns and still meet an insulation industry standard permeability or permeance of less than 1 Perm, at a humidity within a lower humidity range, when tested in accordance with ASTM E-96 “Standard Test Method for Water Vapor Transmission of Materials” Procedure A desiccant-dry cup method. However, such a reduced thickness is impractical, because a smart vapor retarder of reduced film thickness loses its tear strength and becomes fragile and susceptible to being damaged during manufacture thereof, and during shipping, handling and installation at a construction site for a building. Prior to the invention, no motivation existed for reducing the thickness of a smart vapor retarder, since the reduced thickness would have an inability to overcome the decreased strength and the damage thereto from shipping, handling and installation of such a thin film.

### SUMMARY OF THE INVENTION

According to the invention, a reinforced vapor retarding film comprises a combination of a fibrous reinforcement bonded to a humidity adaptive, vapor retarding thin film, wherein the combination has a tear strength greater than that of the thin film alone and has at least a minimum tear strength for an unreinforced thicker film of the same material as the thin film to withstand shipping, handling and installation. Advantageously, the combination has at least the tear strength of a thicker film for ease of handling, staple holding strength and resistance to damage.

Further, advantageously, the combination has a vapor permeability that meets an industry standard permeability. For example, the 2003 International Building Code defines a vapor retarder as, “A vapor resistant material, membrane or covering, such as foil, plastic sheeting or insulation facing having a permeance rating of 1 Perm (5.7×10⁻¹¹ kg/Pa·s·m²) or less, when tested in accordance with the dessicant method using Procedure A of ASTM E 96.” Further, the 2003 International Energy Conservation Code specifies in section 502.1.1 Moisture Control, “Frame wall, floors, and ceilings not ventilated to allow moisture to escape shall be provided with an approved vapor retarder having a permeance of 1 Perm (5.7×10⁻¹¹ kg/Pa·s·m²) or less, when tested in accordance with the dessicant method using Procedure A of ASTM E 96.” Further, advantageously, the invention reduces the material cost of a thicker vapor retarding film by reducing the film's thickness while providing a tear strength greater than that of the thin film alone and providing at least a minimum tear strength similar to an unreinforced thicker film of the same material to permit the thin film to withstand shipping, handling and installation. The thin film is reinforced to serve as a stand-alone building product that resists damage thereto. According to an embodiment of the invention, the fibrous reinforcement comprises a non-adhesive material at earth atmospheric temperatures and pressures.

Further, according to the invention a method of making a reinforced vapor retarding film includes, melt blowing or melt spraying polymeric fibers, melt bonding the fibers together to form a fibrous reinforcement, and melt bonding the fibers to a humidity adaptive, vapor retarding thin film, such that a combination of the reinforcement and the thin film has a tear strength greater than that of the thin film alone and has at least a minimum tear strength for an unreinforced thicker film of the same material as the thin film to withstand shipping, handling and installation.

According to an embodiment of the invention, the reinforcement comprises polymeric fibers forming a water vapor porous web, and the fibers are melt bonded on at least one surface of the thin film. According to another embodiment of the invention, the fibers of the porous web are melt bonded on opposite surfaces of the thin film. In a preferred embodiment of the invention, the thin film comprises nylon, polyvinyl alcohol (PVOH), ethylene vinyl alcohol (EVOH), ethylene vinyl acetate, polyethylene, polypropylene, polyurethane or a combination thereof. According to another embodiment of the invention, the polymeric fiber reinforcement comprises a melt blown or melt sprayed, bonded layer of fibers comprising polyethylene, polypropylene, ionomer, ethylene methyl acrylate, ethylene acrylic acid, polyacetal (Acetal), polybutylene terephthalate (PBT), polyphthalate carbonate, polyethylene terephthalate (PET), polylactic acid, styrene acrylonitrile, acrylonitrile styrene acrylate, polyethersulfone, polystyrene, ethylene vinyl acetate, nylon, polyester, polyvinyl chloride, ethylene vinyl alcohol, polycarbonate, acrylonitrile butadiene styrene (ABS), polyoxymethylene, polyoxymethyl methacrylate, or a blend of two or more of these materials. According to another embodiment of the invention, the reinforced vapor retarding film is adhered to a substrate selected from gypsum board, fibrous insulation batt or blanket, fibrous insulation board, open cell polyurethane foam, duct liner or ceiling tile. In another embodiment of the invention, the reinforced vapor retarding film is adhered to the substrate by melt bonding of the fibers or by an adhesive that is water insoluble after setting, including but not limited to, a hot melt adhesive or a water based adhesive.

### BRIEF DESCRIPTION OF THE DRAWINGS

Embodiments of the invention will now be described by way of example with reference to the drawings.

FIG. 1 is an isometric view of a portion of a building product.

FIG. 2 is a schematic elevation view of a manufacturing apparatus performing a method of making the building product disclosed by FIG. 1.

### DETAILED DESCRIPTION

An exemplary vapor permeable film comprises a smart vapor permeable membrane, i.e., a membrane that changes its moisture vapor permeability with the ambient humidity condition. An exemplary vapor permeable film changes its water vapor permeability with the ambient humidity condition. Such permeability is further referred to as a water vapor diffusion resistance, permeability, or transmission rate therethrough which is dependent on the ambient humidity or relative humidity and the film thickness. Water vapor permeability may be measured by ASTM E96-00 “Standard Test Method for Water Vapor Transmission of Materials.” The film's permeability may be 1 Perm or less when tested in accordance with ASTM E-96 Procedure A, dry cup method at 25% mean relative humidity. The film's permeability may increase to greater than 10 perms when tested using ASTM E-96 Procedure B the wet cup method at 75% mean relative humidity. This film property of adapting to high humidity with increased water vapor permeability allows a building construction, such as an insulated wall, to increase its drying potential dependent upon the presence of water. The film reacts and adapts to changes in relative humidity—which has significance in regard to building materials' endurance and susceptibility to mold growth when relative humidity increases above 60 percent—by increasing its water vapor permeability with increasing concentrations of moisture. This transformation allows drying to occur through the process of vapor diffusion through the film thickness, thereby improving the speed of drying of the insulation materials and other building components such as sheathing and framing lumber. The humidity adaptive film allows trapped moisture to escape, thereby alleviating a consequent formation of mold and water damage typically associated with excess trapped moisture in the insulation and other building materials. It would be desirable to reduce the material cost of the vapor permeable film by reducing the thickness of the film to become a thin film.

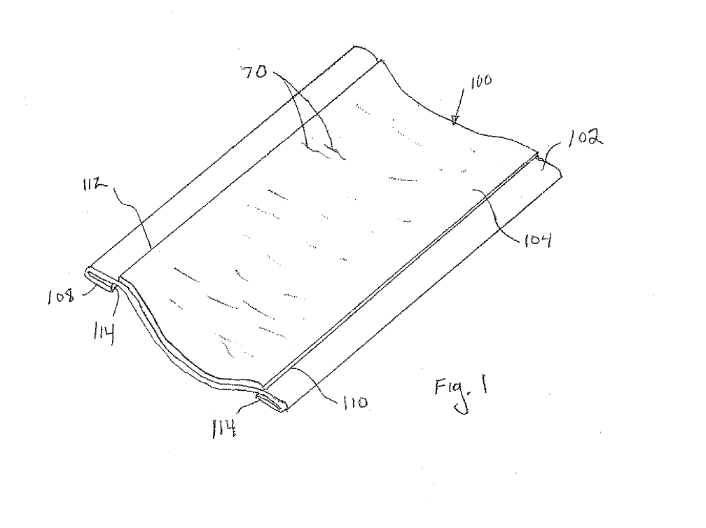

The terminology, “thin film,” refers to a humidity adaptive, vapor retarding film of lower thickness than a thicker film of the same material, and further lacking the minimum tear strength needed by the thicker film for resisting tearing during shipment, handling and installation. The thin film comprises a unitary thin film of continuous material as distinguished from fibers, strands or filaments. FIG. 1 discloses a building product in the form of a reinforced vapor retarding film 100, which comprises a combination of a flexible, thin film 102 of a humidity adaptive vapor retarding material, and a fibrous, flexible, non-continuous, water vapor porous reinforcement 104, such that the combination of the reinforcement 104 and the thin film 102 has a tear strength greater than that of the thin film 102 alone, and has at least a minimum tear strength needed by an unreinforced thicker film of the same material as the thin film 102 to withstand shipping, handling and installation. The tear strength is permitted to exceed the minimum tear strength, and is attained by selecting the reinforcement fibers 104 with a material composition having a corresponding tensile strength per unit of fibrous cross section. The combination permits a reduction of thickness of the thin film material below that which is practical to possess an ease of handling, tear strength, staple holding strength, and resistance to damage. Advantageously, the combination of the thin film 102 and reinforcement 104 has a lower materials cost than the thicker film of the same material as the thin film 102. The reinforcement 104 contributes added strength to the combination. The combination comprising the thin film 102 and the reinforcement 104 has sufficient tensile and/or tear strength to comprise a stand-alone building product 100 withstanding the stresses of shipping, handling and installation in building and/or construction applications.

With reference to FIG. 1, the lateral width of the thin film 102 comprises an embodiment that is laterally wider than the lateral width of the reinforcement 104 to have continuous lateral edges 106, 108 of the thin film 102 bordering the lateral edges 110, 112 of the reinforcement 104 and extending laterally beyond the lateral edges 110, 112 of the reinforcement 104. In a further embodiment, the lateral edges 106, 108 of the thin film 102 are doubled back on themselves and folded for increased strength and to provide stapling flanges into which staples are to be driven to install the building product at a construction site for a building or building improvement. In another embodiment, adhesive 114 is sandwiched between the doubled back and folded portions. For example, each of the stapling flanges measures between about one and four inches (between about 2.5 and 10 cm) in lateral width, and is preferably about 1.25 inches (about 3.18 cm.) wide.

In another embodiment, the fibrous reinforcement 104 comprises the same width as the thin film 102, and the combination of the thin film 102 and reinforcement 104 together provide adequate tear strength and tensile strength and bulk without the need to double back the lateral edges of the film.

Preferably the reinforcement 104 comprises melt formed fibers 70. Preferably the thin film 102 comprises a thermoplastic polymeric composition, for example, a polyamide film, an ethylene vinyl alcohol film, a polyvinyl alcohol film or coating, combinations and coextrusions and blends of such compositions with one another and combinations with other polymeric materials, such as polyethylene, polypropylene, ionomer, ethylene vinyl acetate, polyethylene with a polar maleic anhydride appendage and polypropylene with a polar maleic anhydride appendage. Further, the thin film 102 includes, but is not limited to, a thermoplastic polymeric composition having a melt forming temperature higher than the melt forming temperature of the reinforcement 104. A preferred embodiment of the thin film 102 comprises an extruded, solid thin film 102.

### EXAMPLE 1

An embodiment of the present invention comprises a plurality of polyethylene fibers melt bonded to extruded thin films, and each of the films comprises nylon, EVOH or PVOH. A combination of the thin extruded film and the polyethylene fibers has a water vapor permeance of less than about 1 Perm at 25% mean RH; and about 1-60 Perms at 75% mean RH, Alternatively, a combination of the thin extruded film and the fibers has a water vapor permeance of less than about 0.5 Perm at 25% mean RH; and about 1-60 Perms at 75% mean RH. Alternatively, a combination of the thin extruded film and the fibers has a water vapor permeance of less than about 0.1 Perm at 25% mean RH; and about 1-60 Perms at 75% mean RH. Alternatively, a combination of the thin extruded film and the fibers has a water vapor permeance of less than about 0.2 Perm at 25% mean RH; and about 1-100 Perms at 75% mean RH.

### EXAMPLE II

An embodiment of the present invention comprises a plurality of polypropylene fibers melt bonded to extruded thin films, and each of the films comprises nylon, EVOH or PVOH. A combination of the thin extruded film and the fibers has a water vapor permeance of less than about 1 Perm at 25% mean RH; and about 1-60 Perms at 75% mean RH. Alternatively, a combination of the thin extruded film and the fibers has a water vapor permeance of less than about 0.5 Perm at 25% mean RH; and about 1-60 Perms at 75% mean RH. Alternatively, a combination of the thin extruded film and the fibers has a water vapor permeance of less than about 0.1 Perm at 25% mean RH; and about 1-60 Perms at 75% mean RH. Alternatively, a combination of the thin extruded film and the fibers has a water vapor permeance of less than about 0.2 Perm at 25% mean RH; and about 1-100 Perms at 75% mean RH.

### EXAMPLE III

An embodiment of the present invention comprises a plurality of ethylene vinyl acetate (EVA) fibers melt bonded to extruded thin films, and each of the thin films comprises nylon, EVOH or PVOH. A combination of the thin extruded film and the fibers has a water vapor permeance of less than about 1 Perm at 25% mean RH; and about 1-60 Perms at 75% mean RH. Alternatively, a combination of the thin extruded film and the fibers has a water vapor permeance of less than about 0.5 Perm at 25% mean RH; and about 1-60 Perms at 75% mean RH. Alternatively, a combination of the thin extruded film and the fibers has a water vapor permeance of less than about 0.1 Perm at 25% mean RH; and about 1-60 Perms at 75% mean RH, Alternatively, a combination of the thin extruded film and the fibers has a water vapor permeance of less than about 0.2 Perm at 25% mean RH; and about 1-100 Perms at 75% mean RH.

Although the above examples were obtained by melt bonding polyethylene, polypropylene or EVA fibers to extruded thin films of nylon, EVOH or PVOH, the invention is not limited to the above examples while comprising a combination of a thin film and a melt bonded plurality of thermoplastic fibers, which resists tearing. A combination of the thin film and the thermoplastic fibers has a water vapor permeance of less than about 1 Perm at 25% mean RH; about 1-60 Perms at 75% mean RH. Alternatively, a combination of the thin extruded film and the fibers has a water vapor permeance of less than about 0.5 Perm at 25% mean RH; and about 1-60 Perms at 75% mean RH. Alternatively, a combination of the thin extruded film and the fibers has a water vapor permeance of less than about 0.1 Perm at 25% mean RH; and about 1-60 Perms at 75% mean RH. Alternatively, a combination of the thin extruded film and the fibers has a water vapor permeance of less than about 0.2 Perm at 25% mean RH; and about 1-100 Perms at 75% mean RH.

The unreinforced thicker film of the same material as the thin film 102 is typically manufactured with a film thickness sufficient to provide adequate tear resistance, and to meet an industry standard requirement for water vapor permissivity. For example, the thicker film of the same material as the thin film 102 has a film thickness typically in the range from 10 mu.m. to 2 mm., including, but limited to: 20 .mu.m, 25 .mu.m, 25.4 .mu.m, 25.5 .mu.m, 25.6 .mu.m, 25.7 .mu.m, 25.8 .mu.m, 26 .mu.m, 27 .mu.m, 28 .mu.m, 30 .mu.m, 40 .mu.m, 50 .mu.m, 60 .mu.m, 70 .mu.m, 80 .mu.m, 90 .mu.m, 100 mu.m, 101.6 mu.m, 110 .mu.m, 120 .mu.m, 130 .mu.m, 140 .mu.m, 150 .mu.m, 160 .mu.m, 170 .mu.m, 180 .mu.m, 190 .mu.m, 195 .mu.m, 200 .mu.m and all values and subranges there between, for example, 20 .mu.m to 100 .mu.m, 30 .mu.m to 90 .mu.m, 40 .mu.m to 60 .mu.m, 45.5 .mu.m to 555 .mu.m, for example.

According to an embodiment of the invention, the amount of reinforcing fibers are controlled to a low level that results in only a reduction in humidity adaptive permeance of approximately less than 25%. The thin film has a film thickness that is reduced in half, which approximately doubles such permeance compared to that of the thicker film. Combining the thin film with the fibrous reinforcement then reduces the doubled permeance by less than 25%. For example, in Table 1, a 5.08×10⁻³ cm. (2 mil) film with a permeance of 10 is reduced in thickness by 50% to comprise a thin film, wherein the permeance for the thin film increases to 20. A combination of the thin film with the spray applied fibers of the fibrous reinforcement reduces the permeance of the thin film by 25%, such that the combination of the thin film and the fibrous reinforcement has a permeance of 15.

TABLE 1

| | Water Vapor Permeance | | |
|---|---|---|---|
| Film Thickness and Description | Film A | Film B | Film C |
| 2 mil (5.08 × 10⁻³ cm.) thick | 10 | 0.5 | 0.1 |
| 2 mil thick with spray applied fibers | 7.5 | 0.375 | 0.075 |
| 1 mil (2.54 × 10⁻³ cm.) thick | 20 | 1 | 0.2 |
| 1 mil thick with spray applied fibers | 15 | 0.75 | 0.15 |
| 0.5 mil (1.27 × 10⁻³ cm.) thick | 40 | 2 | 0.4 |
| 0.5 mil thick with spray applied fibers | 30 | 1.5 | 0.3 |

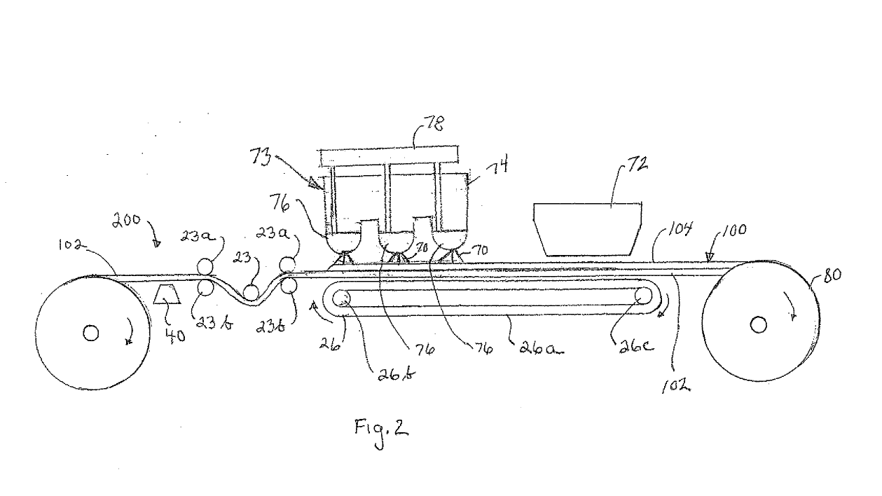

An embodiment of the reinforcement 104 comprises a water vapor porous web in which polymeric fibers 70 melt bond together, and the fibers 70 are melt bonded on at least one surface of the thin film 102. The fibers 70 include, but are not limited to, rovings, strands, or filaments and combinations thereof, as produced by a manufacturing apparatus 200, FIG. 2. Further, the fibers 70 include, but are not limited to, substantially straight axial fibers 70, axially curved fibers 70, random laid fibers 70 extending in random directions, or axially laid fibers 70 extending along one or more predetermined axes, respectively, such as, biaxial and triaxial fibers 70. Preferably the fibers 70 are nonwoven and extend in such directions.

FIG. 2 discloses an apparatus 200 for manufacture of the reinforced vapor retarding film 100. The thin film 102 is unrolled from a continuous roll 21 of the thin film 102. An embodiment of the film is provided with printed information before take-up onto the roll 23 or printing is applied during the manufacturing process by operation of a printing device 40, including but not limited to, an inkjet print head. A series of tension rollers 23 engage and convey the thin film 102. The rollers 23 include pairs of rollers 23a, 23b, one of which comprises a drive roller, and the other an idler roller, to engage opposite sides of the thin film 102 A continuous belt conveyor 26 has a continuous belt 26a, rotatable around rollers 26b, 26c, which conveys the thin film 102 flatly on the belt 26a, and past a melt blowing or melt spraying apparatus 73.

Preferably, the fibers 70 comprise melt blown or melt sprayed fibers 70 made by the melt blowing or melt spraying apparatus 73. The polymer composition for the fibers 70 comprises, resin, plasticizer, pellets, granules or chopped fibers. The polymer composition for the fibers 70 includes, but is not limited to, polyethylene, polypropylene, ionomer, ethylene methyl acrylate, ethylene acrylic acid, polyacetal (Acetal), polybutylene terephthalate (PBT), polyphthalate carbonate, polyethylene terephthalate (PET), polylactic acid, styrene acrylonitrile, acrylonitrile styrene acrylate, polyethersulfone, polystyrene, ethylene vinyl acetate, nylon, polyester, polyvinyl chloride, ethylene vinyl alcohol, polycarbonate, acrylonitrile butadiene styrene (ABS), polyoxymethylene, polyoxymethyl methacrylate, or a blend of two or more of these materials or other suitable thermoplastic material. Low molecular weight, high melt flow index (MFI) material, for example, polypropylene is especially preferred. The polymer composition is suitable when the unit material cost thereof is lower than the unit material cost of the thin film 102.

The polymer composition for the fibers 70 is supplied to a melt polymer feeding apparatus, such as, a screw drive extruder or a hot melt adhesive melting tank and pump 74 to melt and blend the polymer composition and to feed a flowing stream of a blended polymeric melt. The extruder or melt tank and pump 74 feeds the stream of polymeric melt in a metered outflow to each melt blowing or melt spraying head 76 and through one or more fiber forming orifices of each melt blowing or melt spraying head 76. A blowing gas, typically heated air, under pressure is distributed through an air manifold 78 in a metered flow to each melt blowing or melt spraying head 76 and through the orifices thereof, to impel the polymeric melt through the one or more orifices of each melt blowing or melt spraying head 76, which produces the melt blown or melt sprayed fibers 70. According to a preferred embodiment of making the fibers 70, the melt blowing or melt spraying apparatus 73 melts the polymeric composition, and subjects the melted polymeric composition to pressurized air to form melt blown or melt sprayed fibers 70, i.e., melted fibers 70 of which at least the surfaces are in a melted adherent state.

The melt blowing or melt spraying apparatus 73 further impels the melted fibers 70 against the thin film 102. The spacing between the thin film 102 and each melt blowing or melt spraying head is selected to assure that the melted fibers 70 impel against a major surface of the thin film while having melted surfaces in an adherent state to bond to one another and to bond to the thin film 102. The fibers 70 bond to one another and form a fibrous polymeric porous web reinforcement 104. Alternatively, an infrared heater 72 is provided. The fibers 70 and the thin film 102 are conveyed past the infrared heater 72 to heat the fibers 70 and make them tacky to promote their adhesion to the thin film 102 and to one another.

According to an alternative embodiment of the apparatus 73 and a method, an adhesive spray head is substituted for the first melt blowing or melt spraying head 76, such that the spraying head 76 sprays an adherent adhesive on the major surface of the thin film 102 prior to at least one melt blowing or melt spraying head 76 impelling the melted fibers 70 against the major surface. The adhesive on the thin film 102 either temporarily or permanently affixes the melted fibers 70 in place. In a first embodiment, involving some of the applied melted fibers, the adhesive temporarily affixes the fibers to the film for a time period while the melted fibers 70 melt their way through the adhesive, and/or displace the adhesive, and form primary melt bonds with the major surface. Moreover, the adhesive sprayed on the thin film 102, when present, provides an auxiliary bond of the melted fibers 70 with the major surface. In a second embodiment, involving some of the melted fibers, the adhesive permanently affixes the melted fibers 70 in place whenever the adhesive bond is relied upon to augment the melt bond between the melted fibers 70 and the major surface. The adhesive comprises, for example, product number 50-0965 MHV water base adhesive from Henkel Corporation of Avon, Ohio, USA.

The melt blown or melt sprayed fibers 70 adhere by melt bonding to the major surface of the thin film 102, to form a porous fibrous web of melt blown fibers 70. The fibers 70 and the thin film 102 are conveyed away from the corresponding melt blowing heads, and away from the infrared heater 72, if present, to cool the fibers 70 in ambient air to attain a solidified stable state. The fibrous reinforcement 104 comprises a non-adhesive material at earth atmospheric temperatures and pressures. The reinforced vapor retarding film 100 is driven by another pair of rollers 23a, 23b, and is rolled up onto a rotating take-up reel 80 to comprise a finished product suitable for shipment and handling. The reinforced film 100 on the take-up reel 80 has the fibers 70 on one surface and comprises a bi-component, reinforced vapor retarding film 100. According to an alternative manufacturing process, the take-up reel 80 is replaced by continuous lamination of the reinforced film 100 onto a major surface of a substantially elongated building material to produce a laminate of the reinforcing film 100 and the building material that includes, but is not limited to, a fibrous insulation batt, a ductboard insulation or a building panel, further details of which are disclosed in U.S. 2006/0059852 A1.

According to another embodiment, the reinforced film 100 is further manufactured by the apparatus 200 to comprise a tri-component, reinforced vapor retarding film 100, wherein the fibers 70 are distributed on major surfaces on two sides of a thin film 102. The take-up reel 80 is substituted for the supply roll 21 in the apparatus 200. The film 100 is unrolled from the take-up reel 80 in a suitable orientation for receiving fibers 70 on a second surface thereof, such that the reinforcement 104 is constructed in part on each side of the reinforced film 100, and wherein the reinforcement 104 comprises polymeric fibers 70 distributed on two opposite surfaces or sides of the thin film 102.

With reference to FIG. 2, further details of the melt blowing or melt spraying apparatus 73 will now be described. The melt blowing or melt spraying apparatus 73 comprises one or more melt blowing or melt spraying heads 76 that arrange the melted fibers 70 into a distributed pattern or array, and impel the melted fibers 70 toward the thin film 102. Further, the melted fibers 70 become arranged in the pattern or array and melt bond to one another, forming the porous web reinforcement 104. Further, the melted fibers 70 melt bond to the thin film 102 to melt bond the porous web to the thin film and provide a bonded layer of the reinforcement 104. The strength of the porous web and the strengths of individual fibers 70 thereof combine with the thin film 102 to resist damage due to applied tension, compression, abrasion and tearing forces.

In an exemplary embodiment, the melt blowing or melt spraying applicators use the Nordson ProBlue® hot melt unit available from Nordson Corporation of Westlake, Ohio as polymer melter 138a. These melters have tank capacities up to 50 liters. This device melts the thermoplastic polymer and pumps the melted polymer to a hot melt gun. Appropriate applicators are selected for the die and gun in order to form the melted polymer into fibers. One exemplary Nordson applicator is the Nordson Series MB-200 Meltblown Applicator which utilizes air jets to create blown fibers ranging in size from 0.2-50 μm in diameter and shorter than 200 mm in length. Various dies and number of dies are attached to the MB-200 Meltblown Applicator to adjust fiber size and coverage. Another exemplary applicator is the Nordson MELTEX® Series EP 11 Slot Gun applicator, which has an application width of 400 mm or more. Still further, another exemplary applicator is the Nordson CONTROL COAT® System applicator, which produces fine fibers by impinging heated air on the hot melt as it is extruded through slot openings to stretch and shred the blown adhesive. Exemplary nozzles for the die include Nordson UNIVERAL™ CF® (Controlled Fiberization) nozzles, Nordson EP nozzles, and Nordson UNIVERSAL™ SUMMIT™ nozzles. The diameter and length of the thermoplastic polymer fibers may be controlled by several process parameters, including polymer temperature, fluid pressure, atomizing air pressure, fluid flow rate, and nozzle orifice size. The choice of the polymer and its melt index may also affect the fiber and particle size. In one embodiment, the thermoplastic fibers have average diameters between about 0.2 to about 20 μm, and more preferably between about 0.5 to about 15 μm. These fibers have average lengths between about 0.1 to about 15 mm, and more preferably between about 0.1 to about 6 mm.

According to a preferred embodiment of making the web reinforcement 104, the melt blowing apparatus 73 comprises a melt spraying apparatus 73. The one or more melt blowing heads 76 comprise one or more melt spraying heads 76. Each of the melt spraying heads 76 produces melt formed fibers 70 that are sprayed by the melt spraying heads 76 to be impelled toward the thin film 102 and to distribute the fibers 70 in a distributed pattern or array. For example, the fibers 70 are distributed in a random pattern or array. The melted fibers 70 melt bond to one another to form the porous web reinforcement 104. Further, the melted fibers 70 melt bond to the thin film 102, to melt bond the porous web reinforcement 104 to the thin film 102, and provide a bonded layer of reinforcement 104. The one or more melt blowing heads 76 distribute the fibers 70 to form the reinforcement 104 immediately prior to, or simultaneous with, melt bonding of the fibers 70 against the thin film 102.

The number of fibers 70 and area distribution thereof deposited per unit area of the surface of the thin film 102 determines the water vapor porosity of the reinforcement 104 and is controlled to insure that the thin film 102, and fibrous reinforcement maintains its smart vapor retarder properties. Moreover, the number of fibers 70 and distribution thereof determines the tensile strength of the web reinforcement 104. An even distribution of the melt blown polymeric fibers 70 over the surface of the thin film 102 is preferred. The first melt blowing or melt spraying head 76 distributes a pattern of melt blown fibers 70, which may be sufficient in number and distribution to avoid the need for additional melt blowing or melt spraying heads 76 to distribute further blown fibers 70. The melt blown fibers 70 melt bond to one another to form the porous web reinforcement 104, with interconnected fibers 70 being bonded together and having a desired tensile strength to resist tearing, and further to resist tearing of the thin film 102 to which the web bonds. The porous web reinforcement 104 further provides an abrasion resisting layer, and raises the surface friction coefficient of the thin film 102 to overcome slipperiness when grasped, and further provides a parting surface layer of the fibers 70 to overcome electrostatic charge build-up of the thin film 102.

Table 2 includes ASTM E96 Procedure A Dry Cup Test data collected at 73 degrees F., 50% relative humidity (RH) in the test chamber, 0% RH in the cup, mean RH=25%, except that the first two rows (marked by the asterisks) are published values presented for comparison only. As is apparent from Table 2, the permeance varies with thickness, and also varies among different formulations of the same generic material (e.g., compare performance of the Soarus EVOH-29 and EVOH-44 films having a common thickness, where 29 and 44 signify the mole percentage of ethylene in the polymer molecule). The tables include products sold by Honeywell International, Pottsville, Pa.; EVAL Company of America Houston, Tex.; Soarus, LLC, Arlington Heights, Ill.; Escorene by ExxonMobil, Baytown, Tex.; Clysar by Bemis Corporation Oshkosh, Wis.; Bovlon by Mitsui Plastics, White Plains, N.Y.; by SKC America, Inc., Covington, Ga.; by American Profol Inc., Cedar Rapids, Iowa; by Grafix Plastics, Cleveland, Ohio; by GE Polymershapes of Huntersville, N.C.; and by Deerfield Urethane, Inc of South Deerfield, Mass.

TABLE 2

| | Thickness | ASTM E96 Dry Cup |
|---|---|---|
| Plastic Film | cm. (in.) | Perm at 25% mean RH |
| Polyamide (U.S. Pat. No. 6808772) * | | 0.69 to 1.72 |
| Intello Product * | | 0.31 |
| (polyethylene copolymer membrane on polyethylene non-woven felt) | | |
| Honeywell Capran ® 0.002″ thick Nylon 6 film not biaxially oriented | 5.08 × 10⁻³ (0.002) | 0.76 |
| Honeywell Capran ® Emblem ™2500 0.001″ Biaxially Oriented Nylon | 2.54 × 10⁻³ (0.001) | 1.10 |
| Honeywell Capran ® Emblem ™1500 0.0006″ Biaxially Oriented Nylon | 1.52 × 10⁻³ (0.0006) | 1.64 |
| Honeywell Capran ® Oxyshield ™ OXTR machine direction oriented | 2.54 × 10⁻³ (0.001) | 0.11 |
| (coextrusion of Nylon and EVOH) | | |
| Honeywell Capran ® Oxyshield ™ OBS machine direction oriented | 1.65 × 10⁻³ (0.00065) | 0.38 |
| (coextrusion of Nylon and EVOH) | | |
| EVAL EVOH EF-E 44 mole % ethylene | 3.0 × 10⁻³ (0.0012) | 0.109 |
| EVAL EVOH EF-CR 27 mole % ethylene | 2.28 × 10⁻³ (0.0009) | 0.141 |
| Soarus EVOH-29, 29 mole % ethylene | 3.0 × 10⁻³ (0.0012) | 0.035 |
| Soarus EVOH 44, 44 mole % ethylene | 3.0 × 10⁻³ (0.0012) | 0.066 |
| ExxonMobil Escorene Ultra EVA LD719.93 15% vinyl acetate | 3.56 × 10⁻³ (0.0014) | 2.11 |
| copolymer | | |
| ExxonMobil Escorene Ultra EVA LD720.01 19.3% vinyl acetate | 3.56 × 10⁻³ (0.0014) | 2.14 |
| copolymer | | |
| ExxonMobil Escorene Ultra EVA LD767.mj 29.5% vinyl acetate | 4.57 × 10⁻³ (0.0018) | 4.91 |
| copolymer | | |
| Bemis Clysar LE Polyethylene | 1.52 × 10⁻³ (0.0006) | 0.81 |
| Bovlon Poly Vinyl Alcohol | 1.27 × 10⁻³ (0.0005) | 0.016 |
| Profol Polypropylene | 3.25 × 10⁻³ (0.0013) | 0.16 |
| SKC Polyester | 3.46 × 10⁻³ (0.0014) | 0.40 |
| Deerfield PT9200-US Polyurethane | 2.36 × 10⁻³ (0.00093) | 18.89 |

TABLE 3

| | Thickness | ASTM E96 Wet Cup |
|---|---|---|
| Plastic Film | cm. (in.) | Perm at 75% mean RH |
| Polyamide (U.S. Pat. No. 6808772) * | | >3.45 |
| Intello Product * | | 3.45 |
| (polyethylene copolymer membrane on polyethylene non-woven felt) | | |
| Honeywell Capran ® 0.002″ thick Nylon 6 film not biaxially | 5.08 × 10⁻³ (0.002) | 11.90 |
| oriented | | |
| Honeywell Capran ® Emblem ™2500 0.001″ Biaxially Oriented | 2.54 × 10⁻³ (0.001) | 7.92 |
| Nylon | | |
| Honeywell Capran ® Emblem ™1500 0.0006″ Biaxially Oriented | 1.52 × 10⁻³ (0.0006) | 11.94 |
| Nylon | | |
| Honeywell Capran ® Emblem ™1200 0.00048″ Biaxially Oriented | 1.17 × 10⁻³ (0.0005) | 14.61 |
| Nylon | | |
| Honeywell Capran ® Oxyshield ™ OXTR machine direction | 2.54 × 10⁻³ (0.001) | 5.09 |
| oriented (coextrusion of Nylon and EVOH) | | |
| Honeywell Capran ® Oxyshield ™ OBS machine direction oriented | 1.65 × 10⁻³ (0.00065) | 3.88 |
| (coextrusion of Nylon and EVOH) | | |
| EVAL EVOH EF-E 44 mole % ethylene | 3.05 × 10⁻³ (0.0012) | 0.95 |
| EVAL EVOH EF-CR 27 mole % ethylene | 2.29 × 10⁻³ (0.0009) | 14.77 |
| Soarus EVOH 29, 29 mole % ethylene | 3.05 × 10⁻³ (0.0012) | 11.88 |
| Soarus EVOH 44, 44 mole % ethylene | 3.05 × 10⁻³ (0.0012) | 2.03 |
| ExxonMobil Escorene Ultra EVA LD719.93 15% vinyl acetate | 3.56 × 10⁻³ (0.0014) | 1.50 |
| copolymer | | |
| ExxonMobil Escorene Ultra EVA LD720.01 19.3% vinyl acetate | 3.56 × 10⁻³ (0.0014) | 1.32 |
| copolymer | | |
| ExxonMobil Escorene Ultra EVA LD767.mj 29.5% vinyl acetate | 4.57 × 10⁻³ (0.0018) | 3.54 |
| copolymer | | |
| Bemis Clysar LE Polyethylene | 1.52 × 10⁻³ (0.0006) | 0.57 |
| Bovlon Poly Vinyl Alcohol | 1.27 × 10⁻³ (0.0005) | 25.83 |
| Profol Polypropylene | 3.25 × 10⁻³ (0.0013) | 0.20 |
| SKC Polyester | (0.0014) | 0.33 |
| Deerfield PT9200-US Polyurethane | 2.36 × 10⁻³ (0.00093) | 25.12 |

Table 3 includes ASTM E96 Procedure B Wet Cup Test data at 73° F., 50% RH in the test chamber, 100% RH in the cup, mean RH=75%, except that the first two rows (marked by the asterisks) are published values presented for comparison only.

In some embodiments, an adaptive vapor barrier material is coextruded or laminated with another (preferably less expensive) material. For example, a coextruded film may include EVOH coextruded with Nylon (polyamide or PA) and/or ethylene vinyl acetate (EVA) and/or polyethylene (PE), and/or polypropylene, and/or PVOH; or ethylene vinyl acetate (EVA) coextruded with Nylon, or a laminated film may include EVOH laminated with polyester, or EVOH with PVC, or EVOH with polycarbonate, or EVOH with polyurethane. Alternatively, PVOH is coextruded or laminated with another polymer, such as PE or nylon. The tables that follow include several materials that may be used as smart vapor retarders in exemplary embodiments, either alone or combined in a coextrusion, laminate or blend with other polymers.

Coextrusion comprises a form of a lamination process, wherein layers are fused together to produce a laminate of such layers, including but not limited to, coextrusion, hot melt bonding or adhesive bonding. In general, for the above materials, when two thermoplastics are chemically compatible to form a chemical bond while in melt form, they are melt formed into layers and combined by coextrusion through a coextrusion die to form a composite or laminate by the melt form surfaces of the layers being in contact with one another and applying contact pressure. When the two thermoplastics are not compatible they are made into separate layers and combined to form a laminate by placing an adhesive between the incompatible layers and applying contact pressure. Use of a coextruded or laminated film provides the strength and cost advantage of the lower cost film (e.g., polyethylene or polypropylene) while still providing an acceptable range of permeance values at different levels of humidity.

In the coextruded and laminated films described below, the calculations are based on the equation:

Permeability of multilayer films: P_{T}=L_{T}/[(Lₐ/Pₐ)+(L_{b}/P_{b})+ . . . (Lₙ/Pₙ)]
where, P is permeance and L is thickness, the subscript T indicates “Total”, and the other subscripts indicate individual layers. (See Kay Cooksey, Kenneth S. Marsh and Leroy H. Doar, “Predicting Permeability & Transmission Rate for Multilayer Materials”; Food Technology, September 1999, Vol. 53′ No. 9, pages 60-63).

Since a film's permeability is directly related to the film's thickness, for any given material, the calculated permeance of a second film having twice the thickness of a first film will be one half of the permeance of the first film. Also, since a film's permeability is directly related to the film's thickness, for any given material, the calculated permeance of a second film having one half the thickness of a first film will be two times the permeance of the first film.

Table 4 presents calculated permeance data for the Soarus EVOH-29 and EVOH-44 films for 0.0006″ inch thickness, based on the measured data for 0.0012 inch thickness (Tables 1 and 2). These 0.0006″ thick films may be strengthened through the addition of a spray applied fibrous reinforcement. These 0.0006″ thick films could be further reduced in thickness to 0.0003 in a biaxial orientation process and then strengthened through the addition of a spray applied fibrous reinforcement. Reducing the films' thickness by one half will increase their permeability twofold. This doubling of permeability does not result in the reinforced thin films ASTM E96 25% mean RH permeability to rise above the industry standard of one Perm maximum.

TABLE 4

| | Thickness | ASTM |
|---|---|---|
| | cm. (in.) | E96 Perm |
| Soarus EVOH-29 @ mean 25% RH | 1.52 × 10⁻³ | 0.07 |
| | (0.0006) | |
| Soarus EVOH 29 @ mean 75% RH | 1.52 × 10⁻³ | 24 |
| | ⁽0.0006) | |
| Soarus EVOH 44 @ mean 25% RH | 1.52 × 10⁻³ | 0.13 |
| | ⁽0.0006) | |
| Soarus EVOH 44 @ mean 75% RH | 1.52 × 10⁻³ | 4.1 |
| | ⁽0.0006) | |

Table 5 presents calculated permeance data of 1.52×10⁻³ cm. (0.0006 in.) thick EVOH, EVAL EVOH EF-E 44 mole % ethylene. These values are calculated based on the measured permeance of the same material in 3.05×10⁻³ cm. (0.0012 in.) thickness (Tables 1 and 2). This 1.52×10⁻³ cm. (0.0006 in.) thick film may be strengthened through the addition of fibrous reinforcement. This 1.52×10⁻³ cm. (0.0006 in.) film could be further reduced in thickness to 0.76×10⁻³ cm. (0.0003 in.) in a biaxial orientation process and then strengthened through the addition of a spray applied fibrous reinforcement. Reducing this film's thickness by one half will increase its permeability twofold. This doubling of permeability does not result in the reinforced thin films ASTM E96 25% mean RH permeability to rise above the industry standard of one Perm maximum.

TABLE 5

| | Thickness | ASTM |
|---|---|---|
| | cm. (in.) | E96 Perm |
| Eval EVOH EF-E 44 | 1.52 × 10⁻³ | 0.2 |
| mole % ethylene @ | (0.0006) | |
| mean 25% RH | | |
| Eval EVOH EF-E 44 | 1.52 × 10⁻³ | 2 |
| mole % ethylene @ | (0.0006) | |
| mean 75% RH | | |

Table 6 presents calculated permeance data of 1.14×10⁻³ cm. (0.00045 in.) thick EVOH, Eval EVOH EF-CR 27 mole % ethylene. These values are calculated based on the measured permeance of the same material in 2.29×10⁻³ cm. (0.0009 in.) thickness (Tables 2 and 3). This 1.14×10⁻³ cm. (0.00045 in.) thick film may be strengthened through the addition of fibrous reinforcement.

TABLE 6

| | Thickness | ASTM |
|---|---|---|
| | cm. (in.) | E96 Perm |
| Eval EVOH EF-CR | 1.14 × 10⁻³ | 0.3 |
| @ mean 25% RH | (0.00045) | |
| EVAL EVOH EF-CR | 1.14 × 10⁻³ | 30 |
| @ mean 75% RH | (0.00045) | |

Table 7 presents calculated permeance data for a coextruded EVOH/EVA film, based on the individual layer characteristics. This 4.06×10⁻³ cm. (0.0016 in.) thick film could be further reduced in thickness to 2.03×10⁻³ cm. (0.0008 in.) by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum. This 2.03×10⁻³ cm. (0.0008 in.) thick film could be further reduced in thickness to 1.02×10⁻³ cm. (0.0004 in.) in a biaxial orientation process and then strengthened through the addition of a spray applied fibrous reinforcement. Reducing this film's thickness by one half will increase its permeability twofold. This further doubling of permeability does not result in the reinforced thin film's ASTM E96 25% mean RH permeability to rise above the industry standard of one Perm maximum.

TABLE 7

| | | | ExxonMobil Escorene | |
|---|---|---|---|---|
| | | | Ultra EVA LD719.93 | |
| Total Thickness | | | 15% vinyl acetate | |
| cm. (in.) | EVOH EF CR | | copolymer | |
| 4.06 × 10⁻³ | Layer 1 | | Layer 2 | |
| (0.0016) | Thickness | Perm | Thickness | Perm |
| Total ASTM Perms | | | | |
| @ mean 25% | | | | |
| 0.2 | 2.29 × 10⁻³ | 0.141 | 1.78 × 10⁻³ | 4.2 |
| | (0.0009) | | (0.0007) | |
| Total ASTM Perms | | | | |
| @ mean 75% RH | | | | |
| 5 | 2.29 × 10⁻³ | 14.77 | 1.78 × 10⁻³ | 3 |
| | (0.0009) | | (0.0007) | |

Table 8 presents calculated permeance data for a coextruded EVOH/Nylon/EVOH film, based on the individual layer characteristics. This 0.0021″ thick film could be further reduced in thickness to 0.0007″ by coextruding a thinner film and then strengthened through the addition of a spray applied fibrous reinforcement. Reducing the film's thickness by one third will increase its permeability threefold. This tripling of permeability does not result in the reinforced thin film's ASTM E96 25% mean RH permeability to rise above the industry standard of one Perm maximum.

TABLE 8

| | Soarus EVOH 44 | | | | EVOH EF CR | |
|---|---|---|---|---|---|---|
| | Layer 1 | | | | Layer 3 | |
| Total Thickness | Thickness | | Nylon | | Thickness | |
| 5.33 × 10⁻³ cm. | 1.52 × 10⁻³ | | Layer 2 | | 1.14 × 10⁻³ | |
| (0.0021 in.) | cm. | Perm | Thickness | Perm | cm. | Perm |
| Total ASTM Perms | | | | | | |
| @ mean. 25% RH | | | | | | |
| 0.3 | (0.0006 in.) | 0.13 | (0.001 in.) | 1.5 | (0.00045 in.) | 0.3 |
| Total ASTM Perms | | | | | | |
| @ mean 75% RH | | | | | | |
| 10 | 0.0006 in.) | 4.1 | (0.001 in.) | 24 | (0.00045 in.) | 30 |

Table 9 presents calculated permeance data for a coextruded EVOH/PE/EVOH film, based on the individual layer characteristics. This 3.81×10⁻³ cm. (0.0015 in.) thick film could be further reduced in thickness to 1.90×10⁻³ cm. (0.00075 inch) by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum.

TABLE 9

| | | | Bemis Clysar LE | | | |
|---|---|---|---|---|---|---|
| | EVOH EF CR | | Polyethylene | | EVOH EF CR | |
| | Layer 1 | | Layer 2 | | Layer 3 | |
| Total Thickness | Thickness | | Thickness | | Thickness | |
| cm. (in.) | 1.14 × 10⁻³ | | 1.52 × 10⁻³ | | 1.14 × 10⁻³ | |
| 3.81 × 10⁻³ (0.0015) | cm. | Perm | cm. | Perm | cm. | Perm |
| Total ASTM Perms | | | | | | |
| @ mean 25% RH | | | | | | |
| 0.4 | 0.00045 | 0.3 | 0.0006 | 0.81 | 0.00045 | 0.3 |
| Total ASTM Perms | | | | | | |
| @ mean 75% RH | | | | | | |
| 1.4 | 0.00045 | 30 | 0.0006 | 0.57 | 0.00045 | 30 |

Table 10 presents calculated permeance data for a coextruded EVOH/PE/EVOH film, based on the individual layer characteristics. This 0.0012″ thick film could be further reduced in thickness to 0.0006″ by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum.

TABLE 10

| | | | Bemis Clysar LE | | | |
|---|---|---|---|---|---|---|
| | EVOH EF CR | | Polyethylene | | EVOH EF CR | |
| | Layer 1 | | Layer 2 | | Layer 3 | |
| Total Thickness | Thickness | | Thickness | | Thickness | |
| cm. (in.) | 1.14 × 10⁻³ | | 0.762 × 10⁻³ | | 1.14 × 10⁻³ | |
| 3.01 × 10⁻³ (0.0012) | cm. | Perm | cm. | Perm | cm. | Perm |
| Total ASTM Perms | | | | | | |
| @ mean 25% RH | | | | | | |
| 0.4 | 0.00045 in. | 0.3 | 0.0003 in. | 1.6 | 0.00045 in. | 0.3 |
| Total ASTM Perms | | | | | | |
| @ mean 75% RH | | | | | | |
| 4 | 0.00045 in. | 30 | 0.0003 in. | 1.1 | 0.00045 in. | 30 |

Table 11 presents calculated permeance data for a coextruded PVOH/PE/PVOH film, based on the individual layer characteristics (Above). This 0.0013″ thick film could be further reduced in thickness to 0.00065″ by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum. This 0.00065″ thick films could be further reduced in thickness to 0.00033″ in a biaxial orientation process and then strengthened through the addition of a spray applied fibrous reinforcement Further reducing this film's thickness by one half will increase its permeability twofold. This further doubling of permeability does not result in the reinforced thin film's ASTM E96 25% mean RH permeability to rise above the industry standard of one Perm maximum.

TABLE 11

| | | | Bemis Clysar LE | | | |
|---|---|---|---|---|---|---|
| Total Thickness | Bovlon PVOH | | Polyethylene | | Bovlon PVOH | |
| cm. (in.) | Layer 1 | | Layer 2 | | Layer 3 | |
| 3.25 × 10⁻³ (0.0013) | Thickness | Perm | Thickness | Perm | Thickness | Perm |
| Total ASTM Perms | | | | | | |
| @ mean 25% RH | | | | | | |
| 0.02 | 1.27 × 10⁻³ | 0.016 | 0.762 × 10⁻³ | 1.6 | 1.27 × 10⁻³ | 0.016 |
| | (0.0005) | | (0.0003) | | (0.0005) | |
| Total ASTM Perms | | | | | | |
| @ mean 75% RH | | | | | | |
| 4 | 1.27 × 10⁻³ | 26 | 0.762 × 10⁻³ | 1.1 | 1.27 × 10⁻³ | 26 |
| | (0.0005) | | (0.0003) | | (0.0005) | |

Table 12 presents calculated permeance data for a coextruded PVOH/EVA/PVOH film, based on the individual layer characteristics. This 0.00177″ thick film could be further reduced in thickness to 0.00085″ by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum. This 0.00085 inch thick film could be further reduced in thickness to 0.00042″ in a biaxial orientation process and then strengthened through the addition of a spray applied fibrous reinforcement. Further reducing this film's thickness by one half will increase its permeability twofold. This further doubling of permeability does not result in the reinforced thin film's ASTM E96 25% mean RH permeability to rise above the industry standard of one Perm maximum.

TABLE 12

| | | | ExxonMobil Escorene | | | |
|---|---|---|---|---|---|---|
| | | | Ultra EVA LD719.93 | | | |
| | | | 15% vinyl acetate | | | |
| Total Thickness | Bovlon PVOH | | copolymer | | Bovlon PVOH | |
| cm. (in.) | Layer 1 | | Layer 2 | | Layer 3 | |
| 4.32 × 10⁻³ (0.0017) | Thickness | Perm | Thickness | Perm | Thickness | Perm |
| Total ASTM Perms | | | | | | |
| @ mean 25% RH | | | | | | |
| 0.03 | 1.27 × 10⁻³ | 0.016 | 0.0007 | 4.2 | 1.27 × 10⁻³ | 0.016 |
| | (0.0005) | | | | (0.0005) | |
| Total ASTM Perms | | | | | | |
| @ mean 75% RH | | | | | | |
| 6 | 1.27 × 10⁻³ | 25.83 | 0.0007 | 3 | 1.27 × 10⁻³ | 25.83 |
| | (0.0005) | | | | (0.0005) | |

Table 13 presents calculated permeance data for a coextruded EVOH/PVOH/EVOH film, based on the individual layer characteristics. This 0.0014″ thick film could be further reduced in thickness to 0.0007″ by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum. This 0.0007″ thick film could be further reduced in thickness to 0.00035″ in a biaxial orientation process and then strengthened through the addition of a spray applied fibrous reinforcement. Further reducing this film's thickness by one half will increase its permeability twofold. This further doubling of permeability does not result in the reinforced thin film's ASTM E96 25% mean RH permeability to rise above the industry standard of one Perm maximum.

TABLE 13

| Total Thickness | EVOH EF CR | | Bovlon PVOH | | EVOH EF CR | |
|---|---|---|---|---|---|---|
| cm. (in.) | Layer 1 | | Layer 2 | | Layer 3 | |
| 3.56 × 10⁻³ (0.0014) | Thickness | Perm | Thickness | Perm | Thickness | Perm |
| Total ASTM Perms | | | | | | |
| @ mean 25% RH | | | | | | |
| 0.04 | 1.14 × 10⁻³ | 0.3 | 1.27 × 10⁻³ | 0.016 | 1.14 × 10⁻³ | 0.3 |
| | (0.00045) | | (0.0005) | | (0.00045) | |
| Total ASTM Perms | | | | | | |
| @ mean 75% RH | | | | | | |
| 28 | 1.14 × 10⁻³ | 30 | 1.27 × 10⁻³ | 25.83 | 1.14 × 10⁻³ | 30 |
| | (0.00045) | | (0.0005) | | (0.00045) | |

Table 14 presents calculated permeance data for a coextruded PVOH/Nylon/PVOH film, based on the individual layer characteristics. This 0.002″ thick film could be further reduced in thickness to 0.001″ by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum. This 0.001″ thick film could be further reduced in thickness to 0.0005″ in a biaxial orientation process and then strengthened through the addition of a spray applied fibrous reinforcement. Further reducing this film's thickness by one half will increase its permeability twofold. This further doubling of permeability does not result in the reinforced thin film's ASTM E96 25% mean RH permeability to rise above the industry standard of one Perm maximum.

TABLE 14

| Total Thickness | Bovlon PVOH | | Nylon | | Bovlon PVOH | |
|---|---|---|---|---|---|---|
| cm. (in.) | Layer 1 | | Layer 2 | | Layer 3 | |
| 5.08 × 10⁻³ (0.0020) | Thickness | Perm | Thickness | Perm | Thickness | Perm |
| Total ASTM Perms | | | | | | |
| @ mean 25% RH | | | | | | |
| 0.03 | 1.27 × 10⁻³ | 0.016 | 2.54 × 10⁻³ | 1.5 | 1.27 × 10⁻³ | 0.016 |
| | (0.0005) | | (0.001) | | (0.0005) | |
| Total ASTM Perms | | | | | | |
| @ mean 75% RH | | | | | | |
| 25 | 1.27 × 10⁻³ | 25.83 | 2.54 × 10⁻³ | 24 | 1.27 × 10⁻³ | 25.83 |
| | (0.0005) | | (0.001) | | (0.0005) | |

Table 15 presents calculated permeance data for a coextruded PVOH/Nylon/EVOH film, based on the individual layer characteristics. This 0.0021″ thick film could be further reduced in thickness to 0.0007″ by coextruding a thinner film and then strengthened through the addition of a spray applied fibrous reinforcement. Reducing the film's thickness by one third will increase its permeability threefold. This tripling of permeability does not result in the reinforced thin film's ASTM E96 25% mean RH permeability to rise above the industry standard of one Perm maximum. This 0.0007″ thick film could be further reduced in thickness to 0.00035″ in a biaxial orientation process and then strengthened through the addition of a spray applied fibrous reinforcement. Further reducing this film's thickness by one half will increase its permeability twofold. This further doubling of permeability does not result in the reinforced thin film's ASTM E96 25% mean RH permeability to rise above the industry standard of one Perm maximum.

TABLE 15

| Total Thickness | Bovlon PVOH | | Nylon | | Soarus EVOH 44 | |
|---|---|---|---|---|---|---|
| cm. (in.) | Layer 1 | | Layer 2 | | Layer 3 | |
| 5.33 × 10⁻³ (0.0021) | Thickness | Perm | Thickness | Perm | Thickness | Perm |
| Total ASTM Perms | | | | | | |
| @ mean 25% RH | | | | | | |
| 0.06 | 1.27 × 10⁻³ | 0.016 | 2.54 × 10⁻³ | 1.5 | 1.52 × 10⁻³ | 0.13 |
| | (0.0005) | | (0.001) | | (0.0006) | |
| Total ASTM Perms | | | | | | |
| @ mean 75% RH | | | | | | |
| 10 | 1.27 × 10⁻³ | 25.83 | 2.54 × 10⁻³ | 24 | 1.52 × 10⁻³ | 4.1 |
| | (0.0005) | | (0.001) | | (0.0006) | |

Table 16 presents calculated permeance data for a coextruded EVOH/PVOH film, based on the individual layer characteristics. This 0.0001″ thick film could be further reduced in thickness to 0.0005″ by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum. This 0.0005″ thick film could be further reduced in thickness to 0.00025″ in a biaxial orientation process and then strengthened through the addition of a spray applied fibrous reinforcement. Further reducing this film's thickness by one half will increase its permeability twofold. This further doubling of permeability does not result in the reinforced thin film's ASTM E96 25% mean RH permeability to rise above the industry standard of one Perm maximum.

TABLE 16

| Total Thickness | | | | |
|---|---|---|---|---|
| cm. (in.) | EVOH EF CR | | Bovlon PVOH | |
| 2.54 × 10⁻³ | Layer 1 | | Layer 2 | |
| (0.001) | Thickness | Perm | Thickness | Perm |
| Total ASTM Perms | | | | |
| @ mean 25% RH | | | | |
| 0.03 | 1.14 × 10⁻³ | 0.3 | 1.27 × 10⁻³ | 0.016 |
| | (0.00045) | | (0.0005) | |
| Total ASTM Perms | | | | |
| @ mean 75% RH | | | | |
| 28 | 1.14 × 10⁻³ | 30 | 1.27 × 10⁻³ | 25.83 |
| | (0.00045) | | (0.0005) | |

Table 17 presents calculated permeance data for a coextruded EVOH/Polypropylene/EVOH film, based on the individual layer characteristics (Above). This 0.0016″ thick film could be further reduced in thickness to 0.0008″ by coextruding a thinner film and then strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum.

TABLE 17

| | | | Profol | | | |
|---|---|---|---|---|---|---|
| Total Thickness | EVOH EF CR | | Polypropylene | | EVOH EF CR | |
| cm. (in.) | Layer 1 | | Layer 2 | | Layer 3 | |
| 4.06 × 10⁻³ (0.0016) | Thickness | Perm | Thickness | Perm | Thickness | Perm |
| Total ASTM Perms | | | | | | |
| @ mean 25% RH | | | | | | |
| 0.3 | 1.14 × 10⁻³ | 0.3 | 1.65 × 10⁻³ | 0.3 | 1.14 × 10⁻³ | 0.3 |
| | (0.00045) | | (0.00065) | | (0.00045) | |
| Total ASTM Perms | | | | | | |
| @ mean 75% RH | | | | | | |
| 1 | 1.14 × 10⁻³ | 30 | 1.65 × 10⁻³ | 0.4 | 1.14 × 10⁻³ | 30 |
| | (0.00045) | | (0.00065) | | (0.00045) | |

Table 18 presents calculated permeance data for a laminated EVOH/Polyester/EVOH film, based on the individual layer characteristics (Above). This 0.0016″thick film could be further reduced in thickness to 0.0008″ by coextruding or otherwise laminating thinner layer films and then being strengthened through the addition of a spray applied fibrous reinforcement. Reducing the film's thickness by one half will increase its permeability twofold. This doubling of permeability does not result in the reinforced thin film's ASTM E96 25% mean RH permeability to rise above the industry standard of one Perm maximum.

TABLE 18

| Total Thickness | EVOH EF CR | | SKC Polyester | | EVOH EF CR | |
|---|---|---|---|---|---|---|
| cm. (in.) | Layer 1 | | Layer 2 | | Layer 3 | |
| 4.06 × 10⁻³ (0.0016) | Thickness | Perm | Thickness | Perm | Thickness | Perm |
| Total ASTM Perms | | | | | | |
| @ mean 25% RH | | | | | | |
| 0.4 | 1.14 × 10⁻³ | 0.3 | 1.78 × 10⁻³ | 0.8 | 1.14 × 10⁻³ | 0.3 |
| | (0.00045) | | (0.0007) | | (0.00045) | |
| Total ASTM Perms | | | | | | |
| @ mean 75% RH | | | | | | |
| 2 | 1.14 × 10⁻³ | 30 | 1.78 × 10⁻³ | 0.7 | 1.14 × 10⁻³ | 30 |
| | (0.00045) | | (0.0007) | | (0.00045) | |

Table 19 presents calculated permeance data for a laminated EVOH/Polyurethane film, based on the individual layer characteristics. This 0.0018″ thick film could be further reduced in thickness to 0.0006 inch by laminating thinner films, and then strengthened through the addition of a spray applied fibrous reinforcement. Reducing the film's thickness by one third will increase its permeability threefold. This tripling of permeability does not result in the reinforced thin film's ASTM E96 25% mean RH permeability to rise above the industry standard of one Perm maximum.

TABLE 19

| | | | Deerfield | |
|---|---|---|---|---|
| Total Thickness | | | Urethane | |
| cm. (in.) | EVOH EF CR | | PT9200-US | |
| 4.57 × 10⁻³ | Layer 1 | | Layer 2 | |
| (0.0018) | Thickness | Perm | Thickness | Perm |
| Total ASTM Perms | | | | |
| @ mean 25% RH | | | | |
| 0.3 | 2.28 × 10⁻³ | 0.141 | 2.36 × 10⁻³ | 18.89 |
| | (0.0018) | | (0.00093) | |
| Total ASTM Perms | | | | |
| @ mean 75% RH | | | | |
| 19 | 2.28 × 10⁻³ | 14.77 | 2.36 × 10⁻³ | 25.12 |
| | (0.0018) | | (0.00093) | |

Table 20 presents a summary of measured and calculated permeances for the adaptive vapor retarders included in Tables 4 through 19.

TABLE 20

| | | ASTM E96 | ASTM E96 | | | | | |
|---|---|---|---|---|---|---|---|---|
| | | Perm @ | Perm @ | Thickness | | | | |
| Measured or | Table | mean 25% | mean 75% | cm. × 10⁻³ | Number of | Layer | Layer | Layer |
| Calculated | Number | RH | RH | (in.) | Layers | 1 | 2 | 3 |
| Measured | 2 & 3 | 0.141 | 14.77 | 2.29 (0.0009) | 1 | EVOH | | |
| Measured | 2 & 3 | 0.38 | 3.88 | 1.65 (0.00065) | 3 | Nylon* | EVOH* | Nylon* |
| Measured | 2 & 3 | 1.64 | 11.94 | 1.52 (0.0006) | 1 | Nylon | | |
| Measured | 2 & 3 | 0.016 | 25.83 | 1.27 (0.0005) | 1 | PVOH | | |
| Calculated | 4 | 0.07 | 24 | 1.52 (0.0006) | 1 | EVOH | | |
| Calculated | 4 | 0.13 | 4.1 | 1.52 (0.0006) | 1 | EVOH | | |
| Calculated | 4 | 0.14 | 48 | 0.762 (0.0003) | 1 | EVOH | | |
| Calculated | 4 | 0.26 | 8.2 | 0.762 (0.0003) | 1 | EVOH | | |
| Calculated | 5 | 0.2 | 2 | 1.52 (0.0006) | 1 | EVOH | | |
| Calculated | 5 | 0.4 | 4 | 0.762 (0.0003) | 1 | EVOH | | |
| Calculated | 6 | 0.3 | 30 | 1.14 (0.00045) | 1 | EVOH | | |
| Calculated | 7 | 0.4 | 10 | 2.03 (0.0008) | 2 | EVOH | EVA | |
| Calculated | 7 | 0.8 | 20 | 1.02 (0.0004) | 2 | EVOH | EVA | |
| Calculated | 8 | 0.9 | 30 | 1.78 (0.0007) | 3 | Nylon | EVOH | Nylon |
| Calculated | 9 | 0.8 | 2.6 | 1.91 (0.00075) | 3 | EVOH | PE | EVOH |
| Calculated | 10 | 0.8 | 8 | 1.52 (0.0006) | 3 | EVOH | PE | EVOH |
| Calculated | 11 | 0.04 | 8 | 1.65 (0.00065) | 3 | PVOH | PE | PVOH |
| Calculated | 11 | 0.08 | 16 | 0.838 (0.00033) | 3 | PVOH | PE | PVOH |
| Calculated | 12 | 0.06 | 12 | 2.16 (0.00085) | 3 | PVOH | EVA | PVOH |
| Calculated | 12 | 0.12 | 24 | 1.07 (0.00042) | 3 | PVOH | EVA | PVOH |
| Calculated | 13 | 0.08 | 56 | 1.78 (0.0007) | 3 | EVOH | PVOH | EVOH |
| Calculated | 14 | 0.06 | 50 | 2.54 (0.001) | 3 | PVOH | Nylon | PVOH |
| Calculated | 14 | 0.12 | 100 | 1.27 (0.0005) | 3 | PVOH | Nylon | PVOH |
| Calculated | 15 | 0.18 | 30 | 1.78 (0.0007) | 3 | PVOH | Nylon | EVOH |
| Calculated | 16 | 0.03 | 28 | 2.54 (0.001) | 2 | EVOH | PVOH | |
| Calculated | 16 | 0.06 | 56 | 1.27 (0.0005) | 2 | EVOH | PVOH | |
| Calculated | 17 | 0.6 | 2 | 2.03 (0.0008) | 3 | EVOH | PP | EVOH |
| Calculated | 18 | 0.8 | 4 | 2.03 (0.0008) | 3 | EVOH | Polyester | EVOH |
| Calculated | 19 | 0.9 | 57 | 1.52 (0.0006) | 2 | EVOH | Urethane | |

*The Oxyshield ™ films are believed to be a three layer construction with Nylon outer layers and an EVOH core.

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivative thereof (e.g., “horizontally,” “downwardly upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like such as “connected” and “interconnected,” refer to a relationship wherein structures are secured or attached to one another either directly or indirectly through intervening structures, as well as both movable or rigid attachments or relationships, unless expressly described otherwise.

Patents, patent applications and publications referred to herein are hereby incorporated by reference in their entireties. Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A reinforced vapor retarding film, comprising:
a combination of a spray applied fibrous polymeric reinforcement bonded to a humidity adaptive vapor retarding thin film; and
the combination having a tear strength greater than that of the thin film alone and at least the same as a minimum tear strength required of an unreinforced thicker film of the same material as the thin film to withstand shipping, handling and installation.

2. The reinforced vapor retarding film of claim 1 wherein the humidity adaptive, water vapor permeance of the thin film alone is reduced by less than 25% while in the combination with the fibrous reinforcement.

3. The reinforced vapor retarding film of claim 1 wherein the fibrous reinforcement comprises a non-adhesive material at earth atmospheric temperatures and pressures.

4. The reinforced vapor retarding film as in claim 1, wherein the fibrous reinforcement comprises polymeric fibers melt bonded together, and the fibrous reinforcement is melt bonded on a surface of the thin film.

5. The reinforced vapor retarding film of claim 1 wherein the reinforcement comprises the reinforcement melt bonded to the thin film.

6. The reinforced vapor retarding film of claim 1 wherein the polymeric fibers comprise melt blown or melt sprayed fibers, and the thin film comprises a thermoplastic polymeric composition.

7. The reinforced vapor retarding film of claim 1 wherein the polymeric fibers comprise melt blown or melt sprayed fibers, and the melt temperature of the melt blown fibers is lower than the melt temperature of the thin film.

8. The reinforced vapor retarding film of claim 1 wherein the reinforcement comprises polymeric fibers distributed on two sides of the thin film.

9. The reinforced vapor retarding film of claim 1 wherein the thin film comprises an extrusion.

10. The reinforced vapor retarding film of claim 1, further comprising:
an adhesive establishing a further bond of the fibers with the thin film.

11. A method of making a reinforced vapor retarding film, comprising:
melt blowing or melt spraying polymeric fibers;
melt bonding the fibers together to form a porous fibrous reinforcement and melt bonding the fibers to a major surface of a humidity adaptive thin film of a material having a vapor permeability dependent on ambient humidity, such that the combination of the reinforcement and the thin film has a tear strength greater than that of the thin film alone and at least the same as a minimum tear strength required of an unreinforced thicker film of the same material as the thin film to withstand shipping, handling and installation.

12. The method of claim 11, comprising:
melt bonding additional fibers to another major surface of the thin film; and
melt bonding the additional fibers together to form another part of the reinforcement.

13. The method of claim 11, comprising:
beating the polymeric fibers with auxiliary heat.

14. The method of claim 11, comprising:
melt bonding additional fibers to another major surface of the thin film; and
melt bonding the additional fibers together to form another part of the reinforcement.

15. The method of claim 11, comprising:
spraying an adhesive on the major surface of the humidity adaptive thin film prior to melt bonding the fibers to the major surface.

16. A reinforced vapor retarding film, comprising:
a combination of a thin film and a melt bonded plurality of thermoplastic fibers which resists tearing of the thin film.

17. The reinforced vapor retarding film of claim 16 wherein said thin film is selected from nylon, EVOH, PVOH or a combination thereof.

18. The reinforced vapor retarding film of claim 16 wherein said thin film is selected from nylon, EVOH, PVOH, polyethylene, polypropylene, ethylene vinyl acetate or a combination thereof.

19. The reinforced vapor retarding film of claim 16 wherein said thermoplastic fibers is selected from polyethylene, polypropylene, ethylene vinyl acetate or a combination thereof.

20. The reinforced vapor retarding film of claim 16 wherein a combination of the thin film and the fibers has a water vapor permeance of less than about 1 Perm at 25% mean RH; and about 1-60 perms at 75% mean RH.

21. The reinforced vapor retarding film of claim 16 wherein a combination of the thin film and the fibers has a water vapor permeance of less than about 0.5 Perm at 25% mean RH; and about 1-60 perms at 75% mean RH.

22. The reinforced vapor retarding film of claim 16 wherein a combination of the thin film and the fibers has a water vapor permeance of less than about 0.1 Perm at 25% RH; and about 1-60 Perms at 75% RH.

23. The reinforced vapor retarding film of claim 16 wherein a combination of the thin film and the fibers has a water vapor permeance of less than about 0.2 Perm at 25% RH; and about 1-100 Perms at 75% RH.

24. Apparatus for making a reinforced vapor retarding film, comprising:
a conveyor to convey a vapor retarding thin film having a vapor permeability dependent on ambient humidity; and
a melt blowing or melt spraying apparatus having one or more melt blowing or melt spraying heads to melt form polymeric fibers and melt bond the fibers to the thin film, such that the combination of the reinforcement and the thin film has a vapor permeability accorded to an unreinforced thicker film of the same material as the thin film.

25. The apparatus of claim 24, further comprising:
a spraying nozzle to spray the thin film with adhesive and form adhesive bonds of the fibers to the thin film.
